(19) United States
(12) Patent Application Publication
(10) Pub. No.: US 2020/0094527 A1
(43) Pub. Date: Mar. 26, 2020

(54) COATING COMPRISING HYDROPHOBIC SILANE AND ARTICLES

(71) Applicant: 3M INNOVATIVE PROPERTIES COMPANY, St.Paul, MN (US)

(72) Inventors: Jun MA, Woodbury, MN (US); Naiyong JING, St. Paul, MN (US); Erika M. SAFFER, Minneapolis, MN (US); Moses M. DAVID, Woodbury, MN (US); David M. MAHLI, Woodbury, MN (US)

(21) Appl. No.: 16/484,510

(22) PCT Filed: Feb. 7, 2018
(86) PCT No.: PCT/IB2018/050762

§ 371 Date: Aug. 8, 2019

Related U.S. Application Data
(60) Provisional application No. 62/459,270, filed on Feb. 15, 2017.

(51) Int. Cl. B32B 17/10; B32B 7/06; B43L 1/00; B32B 5/16; C03C 17/30

(52) U.S. Cl. CPC B32B 17/10027; B32B 7/06; B43L 1/002; B32B 2255/24; C03C 17/30; B32B 2264/102; B32B 5/16

(57) ABSTRACT

Articles are described comprising a surface layer comprising at least one long hydrocarbon chain silane compound (C8-C36) bonded to a siliceous layer such as diamond-like glass. In an embodiment, the siliceous layer has a porosity of no greater than 10% and a thickness no greater than 1 micron. In another embodiment, the siliceous layer comprises 10-50 atomic percent carbon and the article further comprises an organic polymeric base member or a hardcoat layer. Also described are coating compositions comprising at least one C8-C17 hydrocarbon silane compound and at least one C18-C36 hydrosilane compound.

### SUMMARY

A continuing need exits for surfaces that exhibit improved erasability, such as the ability to cleanly remove permanent marker ink with a dry paper towel.

In some favored embodiments, the surface also exhibits good ink receptivity with a variety of writing instruments, including permanent markers and are suitable for writing surfaces of dry erase boards. In other embodiments, the surfaces exhibit a low peel adhesion force and are suitable for use as a release layer.

In one embodiment, an article is described comprising a surface layer comprising at least one (e.g. C8-C36 hydrocarbon) hydrophobic silane compound siloxane bonded to a siliceous, the siliceous layer having a porosity of no greater than 10% and a thickness no greater than 1 micron.

In another embodiment, an article is described comprising a surface layer comprising at least one (e.g. C8-C36 hydrocarbon) hydrophobic silane compound siloxane bonded to a siliceous layer, the siliceous layer comprising 10 to 50 atomic percent carbon, and the article further comprises an organic polymeric base member.

In some embodiments, the siliceous layer is a diamond-like glass thin film layer. The siliceous layer typically has a thickness no greater than and a thickness no greater than 1 micron.

In some embodiments, the article further comprises an organic polymeric base member, such as a (e.g. PET film. In some embodiments, the article further comprises a hardcoat layer disposed between the organic polymeric base member and diamond-like glass layer.

In some embodiments, the article is a dry erase board. Permanent marker can be erased from the surface layer with a dry paper towel. In other embodiments, the surface layer is a release layer.

In yet another embodiment, a coating composition is described comprising at least one C8-C16 hydrocarbon silane compound and at least one C18-C36 hydrocarbon silane compound and optionally an organic solvent. The composition may optionally further comprise other silane compounds.

### BRIEF DESCRIPTION OF DRAWING

The invention is further explained with reference to the drawing wherein:

FIG. 1 is a schematic view of an illustrative embodied article;

FIG. 2 is a schematic view of another illustrative embodied article.

These FIGURES are not to scale and are intended to be merely illustrative and not limiting.

### DETAILED DESCRIPTION OF ILLUSTRATIVE EMBODIMENTS

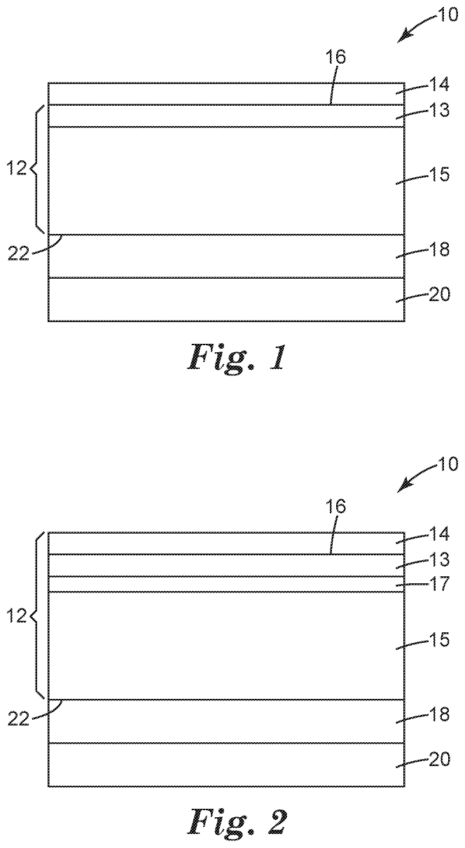

FIG. 1 shows an illustrative embodiment of an article 10 comprising body member 12 with surface layer 14 siloxane bonded to the front surface 16 of a siliceous layer 13. In the embodiment shown, article 10 further comprises optional body member 12 that typically comprises an organic polymeric base member 15. Article 10 further comprises optional adhesive layer 18 and optional removable liner 20 on the back surface 22 of body member 12.

FIG. 2 shows another illustrative embodiment of an article 10 comprising body member 12 with surface layer 14 siloxane bonded to the front surface 16 of a siliceous layer 13. In the embodiment shown, article 10 further comprises optional body member 12 that typically comprises organic polymeric base member 15. A hardcoat layer 17 is disposed between siliceous layer 13 and organic polymeric base member 15. Article 10 further comprises optional adhesive layer 18 and optional removable liner 20 on the back surface 22 of body member 12.

In some embodiments, the base member 15 consists essentially of or has a surface comprising an organic polymer material.

Illustrative examples of organic polymeric materials include polyester (e.g., polyethylene terephthalate (PET), polyethylene naphthalate (PEN), polybutyleneterephthalate), polyolefins (e.g., polypropylene including biaxially oriented polypropylene (BOPP), simultaneously biaxially-oriented polypropylene (S-BOPP), polyethylene), and ethylene or propylene copolymers), melamine resin, polyvinyl chloride, polycarbonate, allyldiglycol carbonate, polyacrylates, such as poly(methylmethacrylate), polystyrene, polysulfone, polyethersulfone, homo-epoxy polymers, epoxy addition polymers with polydiamines, polydithiols, polyethylene copolymers, cellulose esters such as acetate (e.g. TAC) and butyrate, biopolymers such polylactic acid based polymers, and blends thereof.

The organic polymeric base member may optionally further comprise additional organic or inorganic layers (not shown). Such additional layers may comprise glass, metal sheeting, paper, cardboard, knitted materials, fabrics, or the like.

In other embodiments, the base member may comprise an inorganic substrate such as a siliceous material (e.g. glass) or metal.

The base member may be opaque or light-transmissive (e.g. translucent or transparent). The term light-transmissive means transmitting at least about 85% of incident light in the visible spectrum (about 400 to about 700 nm wavelength). Substrates may be colored.

Base members used herein may be flexible or inflexible as desired.

In some embodiments, the base member will be substantially self-supporting, i.e., sufficiently dimensionally stable to hold its shape as it is moved, used, and otherwise manipulated. In some embodiments, the article will be further supported in some fashion, e.g., with a reinforcing frame, adhered to a supporting surface, etc.

In some embodiments, the base member may be provided with graphics on the surface thereof or embedded therein, such as words or symbols as known in the art, which will be visible through the overlying overcoat.

In many embodiments the base member will be substantially planar and may be characterized as a (e.g. preformed) polymeric film. However, the base member but may also be configured in curved, complex, as well as three-dimensional shapes.

The thickness of the base member can vary and will typically depend on the intended use of the final article. In some embodiments, base member (e.g. film) thickness is less than about 0.5 mm and typically between about 0.02 and about 0.2 mm.

Organic polymer base (e.g. film) members can be formed using conventional filmmaking techniques. The base member 15 can be treated to improve adhesion with the adjacent any. Exemplary of such treatments include chemical treatment, corona treatment (e.g., air or nitrogen corona), plasma, flame, or actinic radiation. Interlayer adhesion can also be improved with the use of an optional tie layer or primer applied.

When the finished articles are intended to be used in display panels, the base member 15, and other components (e.g. adhesive 18, hardcoat 17, siliceous layer 13 and surface layer 14) of article 10 are also typically light transmissive, as previously described.

Suitable light transmissive optical film base members include for example multilayer optical films (e.g. U.S. Pat. No. 6,991,695 (Tait et al.) and WO 99/36248 (Neavin et al.), microstructured films such as retroreflective sheeting and brightness enhancing films (e.g. reflective or absorbing), polarizing films, diffusive films, as well as (e.g. biaxial) retarder films and compensator films such as described in U.S. Pat. No. 7,099,083 (Johnson et al.).

At least a portion of the front surface of the body member 12, and in typical embodiments the entire front surface thereof, is siloxane-bondable, i.e., capable of forming siloxane bonds with a hydrophobic silane compound.

This capability is provided by formation of a siliceous layer 13 on the surface of body member 12.

The siliceous layer is generally a continuous layer having a low level of porosity. For example, when a siliceous layer comprises a dried network of acid-sintered nanoparticles as described in WO2012/173803, the siliceous layer of sintered nanoparticles has a porosity of 20 to 50 volume percent, 25 to 45 volume percent, or 30 to 40 volume percent. Porosity may be calculated from the refractive index of the (sintered nanoparticle) primer layer coating according to published procedures such as in W. L. Bragg and A. B. Pippard, Acta Crystallographica, 6, 865 (1953). In contrast the siliceous layer described herein has a porosity less than 20, 15 or 10 volume percent. In some embodiments, the siliceous layer has a porosity of less than 9, 8, 7, 6, 5, 4, 3, 2, or 1 percent.

As also described in WO2012/173803 when the siliceous layer comprises sintered nanoparticles, the porosity tends to correlate to the roughness of the surface. That is, increased surface roughness tends to lead to increased hydrophobicity.

However, low porosity and reduced roughness can be amenable to improved barrier properties, thereby preventing ink or other surface contaminants from penetrating beyond the outer hydrophobic silane layer. The siliceous layer together with the (e.g. well-packed) hydrophobic silane surface layer can provide holdout of marker writing at the surface. Ghosting of dry erase writing can occur when the marker ink penetrates into the surface making it difficult or impossible to remove by simply wiping with a dry eraser. This penetration tends to occur if the writing surface is porous or soft. The present invention provides a writing surface that is not porous thereby preventing ghosting due to penetration of the solvent into the writing surface.

Fused silica is reported to have a refractive index of 1.458. Since air has a refractive index of 1.0, a porous siliceous layer has a lower refractive index than fused silica. For example, when the siliceous layer has a porosity of 20 volume percent, the calculated refractive index would be 1.164.

In some embodiments, siliceous layer 13 further comprises carbon. For example, the siliceous layer may contain from about 10 to about 50 atomic percent carbon. Due to the inclusion of the carbon in combination with the low porosity, the siliceous layer can have a refractive index greater than 1.458 (i.e. fused silica). For example, the refractive index of the siliceous layer can be at least, 1.48, 1.49, 1.50, 1.51, 1.52, 1.53, 1.54, 1.55, 1.56, 1.57, 1.58, 1.59, or 1.60. As the carbon content increase from 30 to 50 atomic percent carbon the refractive index also increases. In some embodiments, the refractive index can range up to 2.2.

The atomic composition (e.g. silicon, carbon, oxygen) of the siliceous layer can be determined by Electron Spectroscopy for Chemical Analysis (ESCA). The presence of Si—C bonding can be determined by Fourier Transform Infrared Spectroscopy (FTIR). Optical properties, such as refractive index, can be determined by Ellipsometry.

In one favored embodiments, the siliceous layer is a diamond-like glass (“DLG”) film, such as described in U.S. Pat. No. 6,696,157 (David et al.). An advantage of such material is that in addition to providing the siloxane-bondable front surface on the body member, such DLG can also provide improved stiffness, dimensional stability, and durability. This is particularly helpful when the underlying components of the base member may be relatively softer.

Illustrative diamond-like glass materials suitable for use herein comprise a carbon-rich diamond-like amorphous covalent system containing carbon, silicon, hydrogen and oxygen. The absence of crystallinity of the amorphous siliceous (e.g. DLG) layer can be determined by X-Ray Diffraction (XRD). The DLG is created by depositing a dense random covalent system comprising carbon, silicon, hydrogen, and oxygen under ion bombardment conditions by locating a substrate on a powered electrode in a radio frequency (“RF”) chemical reactor. In specific implementations, DLG is deposited under intense ion bombardment conditions from mixtures of tetramethylsilane and oxygen. Typically, DLG shows negligible optical absorption in the visible and ultraviolet regions, i.e., about 250 to about 800 nm. Also, DLG usually shows improved resistance to flex-cracking compared to some other types of carbonaceous films and excellent adhesion to many substrates, including ceramics, glass, metals and polymers.

DLG typically contains at least about 30 atomic percent carbon, at least about 25 atomic percent silicon, and less than or equal to about 45 atomic percent oxygen. DLG typically contains from about 30 to about 50 atomic percent carbon. In specific implementations, DLG can include about 25 to about 35 atomic percent silicon. Also, in certain implementations, the DLG includes about 20 to about 40 atomic percent oxygen. In specific advantageous implementations the DLG comprises from about 30 to about 36 atomic percent carbon, from about 26 to about 32 atomic percent silicon, and from about 35 to about 41 atomic percent oxygen on a hydrogen free basis. “Hydrogen free basis” refers to the atomic composition of a material as established by a method such as Electron Spectroscopy for Chemical Analysis (ESCA), which does not detect hydrogen even if large amounts are present in the thin films.

The (e.g. DLG) siliceous layer can made to a specific thickness, typically ranging from at least 50, 75 or 100 nm up to 10 microns. In some embodiments, the thickness is no greater than 5, 4, 3, 2, or 1 micron. In some embodiments, the thickness is less than 1 micron, 900 nm, 800 nm, 700 nm, 600 nm, 500 nm, 400 nm, 300 nm, or 200 nm.

In typical embodiments, the (e.g. DLG) siliceous layer is sufficiently flexible such that it passes the Bend Test described in the forthcoming examples. When the (e.g. DLG) siliceous layer is applied to a sufficiently flexible substrate, such as a (e.g. PET) organic polymeric film. The article is also sufficiently flexible such that the article passes the Bend Test. Even articles that further comprise the hardcoat layer can exhibit such flexibility.

The siliceous layer 13 further comprises a surface layer 14 comprising at least one C8-C36 hydrocarbon silane compound siloxane bonded to the underlying (e.g. DLG) siliceous layer 13.

The silane compound contains both a reactive silyl group and a hydrophobic hydrocarbon group.

The reactive silyl group has at least one hydroxyl group or hydrolyzable group that can react with the DLG layer. The hydrophobic hydrocarbon group typically contains a C8-C36 alkyl, aryl, or combination thereof.

In some embodiments, the surface layer comprises at least a monolayer of the reaction product of the C18-C36 hydrocarbon silane compound siloxane bonded to the underlying siliceous surface. The siliceous layer, exemplified by DLG, can be characterized as planarization layer, thus providing a smooth surface on the substrate. In some embodiments, the siliceous layer has a surface roughness (Ra) of less than 1 micron, 500 nm, 100 nm, 75 nm, 50 nm, 25 nm, or 10 nm. Such surface is suitable for use for example as a release layer. Unlike release layers for pressure sensitive adhesives described in the art, the described release layers are covalently attached (i.e. bonded) to (e.g. DLG) siliceous layer, thus providing durable release surfaces.

In other embodiments, the surface layer comprises at least a monolayer of the reaction product of a mixture of at least one C8 to C17 hydrocarbon silane compound and at least one C18-C36 hydrocarbon silane compound, both siloxane bonded to the underlying siliceous surface. Thus, the (e.g. well-packed) monolayer C18-C36 hydrocarbon is disrupted by the presence of the C8 to C17 hydrocarbon, thus providing a suitable surface tension for good ink receptivity. Such surface is suitable for use for example as a writeable dry erase surface.

The hydrophobic hydrocarbon layer is typically the reaction product of one or more silane compounds of Formula (I).

R¹—Si(R²)₃₋ₓ(R³)ₓ (I)

In Formula (I), group R¹ is independently a C8-C36 alkyl, aryl, or combination thereof (e.g. alkylaryl or arylalkyl). Each R² is independently hydroxyl or a hydrolyzable group. Each R³ is independently a non-hydrolyzable group. Each variable x is an integer equal to 0, 1, or 2.

In some embodiments, suitable alkyl R¹ groups have at least 6, 7, or 8 and typically no greater than 36 carbon atoms. Suitable aryl R¹ groups often have 6 to 18 carbon atoms, 6 to 12 carbon atoms, or 6 to 10 carbon atoms. Some example aryl groups are phenyl, diphenyl, and naphthyl. Some example arylene groups are phenylene, diphenylene, and naphthylene.

Notably R¹ is free of fluorine substituents and free of silicone substituents such as dialkyl(methyl) siloxane repeat units.

Each silane compound has at least one group of formula —Si(R²)₃₋ₓ(R³)ₓ. Each group R² is independently hydroxyl or a hydrolyzable group. Each group R³ is independently a non-hydrolyzable group. The variable x is an integer equal to 0, 1, or 2. The silane compound has a single silyl group and R¹ is monovalent.

In each group of formula —Si(R²)₃₋ₓ(R³)ₓ, there can be one, two, or three R² groups. The R² group is the reaction site for reaction with the underlying siliceous (e.g. DLG) layer. That is, the hydrolyzable group or hydroxyl group reacts with the surface of the siliceous (e.g. DLG) layer DLG layer to covalently attach the silane compound resulting in the formation of a —Si—O—Si—bond. Suitable hydrolyzable R² groups include, for example, alkoxy, aryloxy, aralkyloxy, acyloxy, or halo groups. Suitable alkoxy groups often have 1 to 10 carbon atoms, 1 to 6 carbon atoms, 1 to 4 carbon atoms, or 1 to 3 carbon atoms. Suitable aryloxy groups often have 6 to 12 carbon atoms or 6 to 10 carbon atoms such as, for example, phenoxy. Suitable aralkyloxy group often have an alkoxy group with 1 to 10 carbon atoms, 1 to 6 carbon atoms, or 1 to 4 carbon atoms and an aryl group with 6 to 12 carbon atoms or 6 to 10 carbon atoms. An example aralkyloxy group has an alkoxy group with 1 to 4 carbon atoms with a phenyl group covalently attached to the alkoxy group. Suitable halo groups can be chloro, bromo, or iodo but are often chloro. Suitable acyloxy groups are of formula —O(CO)R^{b} where R^{b} is alkyl, aryl, or aralkyl. Suitable alkyl R^{b} groups often have 1 to 10 carbon atoms, 1 to 6 carbon atoms, or 1 to 4 carbon atoms. Suitable aryl R^{b} groups often have 6 to 12 carbon atoms or 6 to 10 carbon atoms such as, for example, phenyl. Suitable aralkyl R^{b} groups often have an alkyl group with 1 to 10 carbon atoms, 1 to 6 carbon atoms, or 1 to 4 carbon atoms that is substituted with an aryl having 6 to 12 carbon atoms or 6 to 10 carbon atoms such as, for example, phenyl. When there are multiple R² groups, they can be the same or different. In many embodiments, each R² is an alkoxy group or chloro.

If there are fewer than three R² group in each group of formula —C(R¹)₂—Si(R²)₃₋ₓ(R³)ₓ, there is at least one R³ group. The R³ group is a non-hydrolyzable group that is not R¹. When all the non-hydrolyzable groups are independently R¹, x=0 and there are no R³ groups. Many alkyl, aryl, and aralkyl groups are non-hydrolyzable groups. Suitable alkyl groups include those having 1 to 5 carbon atoms, 1 to 4 carbon atoms, or 1 to 3 carbon atoms. When there are multiple R³ groups, these groups can be the same or different.

Suitable silane compounds are commercially available from a variety of vendors. Example silane compounds that contain an alkyl group include, but are not limited to, C₁₀H₂₁—Si(OC₂H₅)₃, C₁₈H₃₇—Si(OC₂H₅)₃, C₁₈H₃₇—Si(Cl)₃, and C₈H₁₇—Si(Cl)₃.

Example silanes that contain an aryl group include, but are not limited to, C₆H₅—Si(OCH₃)₃, C₆H₅—Si(Cl)₃, and C₁₀H₇—Si(OC₂H₅)₃.

Provided that the surface layer has a sufficient amount of the C8-C36 silane compounds siloxane bonded to the siliceous surface to provide the desired release properties or writability and permanent marker removability, small concentrations of other silane compounds (e.g. wherein R1 is less than 8, 7, or 6 such as C1-C4 alkyl or silane compounds according to Formula Ib of WO2012/173803) may optionally be present.

In typical embodiments, the hydrophobic hydrocarbon layer comprises the reaction product of at least one silane compound of Formula 1 wherein R¹ is a (e.g. linear) alkyl group comprising 18 to 36 carbon atoms. In some embodiments, R¹ is no greater than 30, 26, 22, or 18 carbon atoms. When the surface layer comprises predominantly a C18 silane compound according to Formula 1, the surface layer is not sufficiently writable, exhibiting dewetting with both dry erase and permanent markers. However, the surface layer exhibits good marker removability (“4” according to the test method described in the examples). Further, the surface layer exhibits a low peel adhesion force and is suitable for use as a release layer of a pressure sensitive adhesive tape. In some embodiments, the peel adhesion of surface layers useful for release layers is typically less than 100 g/inch, 75 g/inch, 50 g/inch, or 25 g/inch when measured using Magic Tape®.

In some embodiments, the surface layer comprise one or more silane compounds according to Formula 1 wherein R¹ comprises 6 to 16 carbon atoms. Such surface layers are writable, exhibiting no dewetting with both dry erase and permanent markers. However, such surface layers do not adequate permanent marker removability (“3” according to the test method described in the examples).

In yet other embodiments, the surface layer comprises a combination of one or more silane compounds according to Formula 1 wherein R¹ comprises 6 to 16 carbon atoms and one or more silane compounds according to Formula 1 wherein R¹ comprises 18 to 36 carbon atoms. By using a combination of such silane compounds, the writability can be maintained while optimizing the permanent marker removability (“4” according to the test method described in the examples.

Various combination of first C8-C17 silane compounds and second C18-C36 silane compounds can be utilized. In general, the amount by weight of the first C8-C17 silane compounds is greater than the amount by weight of the second C18-C36 silane compounds. In some embodiments, such as when the first silane compound is C8, the weight ratio of the first to second silane compounds is preferably greater than 1:1, but less than 19:1. In other embodiments, such as when the first silane compound is C16, the weight ratio of the first to second silane compounds is preferably greater than 4:1 and may range up to 19:1 or greater. The maximum weight ratio of first to second silane compounds may be 40:1, 35:1, 30:1, or 25:1.

The silane compounds often can be used in neat form (e.g., the silane compounds can be applied by chemical vapor deposition) in the surface treatment of (i.e., in the reaction with) the siliceous (e.g. DLG) layer. Alternatively, the silane compounds can be mixed with one or more organic solvents and/or one or more other optional compound forming a coating composition.

Suitable organic solvents for use in the surface layer coating composition include, but are not limited to, aliphatic alcohols such as, for example, methanol, ethanol, and isopropanol; ketones such as, for example, acetone and methyl ethyl ketone; esters such as, for example, ethyl acetate and methyl formate; ethers such as, for example, diethyl ether, diisopropyl ether, methyl t-butyl ether, and dipropylene glycol monomethyl ether (DPM); alkanes such as, for example, heptane, decane, and other paraffinic (i.e., oleofinic) solvents; as well as various fluorinated solvents.

If an organic solvent is used, the coating compositions often contain an amount of the organic solvent that can dissolve or suspend at least about 0.01, 0.1, or 1 percent by weight of the silane compound based on a total weight of the solvent containing coating composition. In some embodiments, the amount of silane compound ranges up to 3, 4, or 5 percent by weight of the coating composition.

Notably the permanent marker removability of the writable surface layer is provided by the compound of Formula 1. Thus, it is not necessary to include other low surface energy materials, such as fluorocarbon or silicone monomers, oligomers, or polymers. Hence, the writable surface layer and hardcoat composition can be free of such components.

The surface layer may optionally contain a small concentration of other materials. When present such materials are no greater than 10, 9, 8, 7, 6, 5, 4, 3, 2, 1, 0.5, 0.1, 0.005, 0.001 wt.-% of the hydrocarbon siloxane-bonded surface layer. Hence, the surface layer comprises at least 90, 91, 92, 93, 94, 95, 96, 97, 98, 99 wt.-% or greater of the reaction product of the silane compounds according to Formula 1, as previously described.

In some embodiments, such as depicted in FIG. 2, a hardcoat layer is provided between the siliceous (e.g. DLG film) layer and the organic polymeric (e.g. film) body member.

The hardcoat layer can improve the adhesion between the siliceous layer and the organic polymeric body member 15. The hardcoat can also improve the stiffness, dimensional stability, and durability; particularly when the siliceous layer is of a minimal thickness.

The hardcoat of the writable surface layer is the reaction product of one or more polymerizable monomers, oligomers and/or polymers. In some embodiments, the hardcoat layer further comprises particles or nanoparticles.

Polymerizable materials may be, for example, free-radically polymerizable, cationically polymerizable, and/or condensation polymerizable. Useful polymerizable materials include, for example, acrylates and methacrylates, epoxies, polyisocyanates, and trialkoxysilane terminated oligomers and polymers. Preferably, the polymerizable material comprises a free-radically polymerizable material.

Preferably, the polymerizable material comprises a free-radically polymerizable material, such as one or more multi-(meth)acrylate monomers and oligomers.

Useful multi-(meth)acrylate monomers and oligomers include:

(a) di(meth)acryl containing monomers such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated bisphenol A diacrylate, hydroxypivalaldehyde modified trimethylolpropane diacrylate, neopentyl glycol diacrylate, polyethylene glycol diacrylate, propoxylated neopentyl glycol diacrylate, tetraethylene glycol diacrylate, tricyclodecanedimethanol diacrylate, triethylene glycol diacrylate, tripropylene glycol diacrylate;

(b) tri(meth)acryl containing monomers such as glycerol triacrylate, trimethylolpropane triacrylate, ethoxylated triacrylates (e.g., ethoxylated trimethylolpropane triacrylate), propoxylated triacrylates (e.g., propoxylated glyceryl triacrylate, propoxylated trimethylolpropane triacrylate), trimethylolpropane triacrylate, tris(2-hydroxyethyl)isocyanurate triacrylate;

(c) higher functionality (meth)acryl contain in monomer such as ditrimethylolpropane tetraacrylate, dipentaerythritol pentaacrylate, pentaerythritol triacrylate, ethoxylated pentaerythritol tetraacrylate, and caprolactone modified dipentaerythritol hexaacrylate.

Oligomeric (meth)acryl monomers such as, for example, urethane acrylates, polyester acrylates, and epoxy acrylates can also be employed.

Such (meth)acrylate monomers are widely available from vendors such as, for example, Sartomer Company of Exton, Pa.; Cytec Industries of Woodland Park, N; and Aldrich Chemical Company of Milwaukee, Wis.

In some embodiments, the hardcoat composition comprises (e.g. solely) a crosslinking agent comprising at least three (meth)acrylate functional groups. In some embodiments, the crosslinking monomer comprises at least four, five or six (meth)acrylate functional groups. Acrylate functional groups tend to be favored over (meth)acrylate functional groups.

Preferred commercially available crosslinking agent include for example trimethylolpropane triacrylate (commercially available from Sartomer Company, Exton, Pa. under the trade designation “SR351”), ethoxylated trimethylolpropane triacrylate (commercially available from Sartomer Company, Exton, Pa. under the trade designation “SR454”), pentaerythritol tetraacrylate, pentaerythritol triacrylate (commercially available from Sartomer under the trade designation “SR444”), dipentaerythritol pentaacrylate (commercially available from Sartomer under the trade designation “SR399”), ethoxylated pentaerythritol tetraacrylate, ethoxylated pentaerythritol triacrylate (from Sartomer under the trade designation “SR494”), dipentaerythritol hexaacrylate, and tris(2-hydroxy ethyl) isocyanurate triacrylate (from Sartomer under the trade designation “SR368”.

Many of these monomers and oligomer can be characterized has having a high Tg, meaning that the homopolymer of such monomers or oligomers generally have a glass transition temperature of at least 40, 50, 60, 70, 80, 90 or 100° C.

In some embodiments, the hardcoat may comprise at least 5, 10, 15, or 20 wt.-%, typically ranging up to 30 wt-% of low Tg monomer or oligomers, meaning that the homopolymer of such monomers or oligomers generally have a glass transition temperature less than 25 or 0° C. Various, low Tg monomers and oligomer are known. One representative example is ethyoxylated trimethylolpropane triacrylate (Tg=−40° C.)

The hardcoat composition typically comprises a sufficient amount of high Tg polymerizable materials and nanoparticles or other particles such that the writable surface, or in other words the cured hardcoat composition inclusive of the compound comprising a C18-C36 hydrocarbon group, is non-tacky and has a glass transition temperature (Tg) well above room temperature. In typical embodiments, the Tg of the hardcoat is at least 40, 50, 60 70, 80, 90, or 100° C.

In some embodiments, the hardcoat comprises at least 60, 65, 70, 75, or 80 wt.-% of polymerized units of ethylenically unsaturated monomer or oligomers having at least two ethylenically unsaturated groups. In some embodiments, the hardcoat comprises at least 60, 65, 70, 75, or 80 wt.-% of polymerized units of ethylenically unsaturated monomer or oligomers having at least three, four, or five ethylenically unsaturated groups.

Depending on the choice of polymerizable material, the precursor composition may, optionally, contain one or more curatives that assist in polymerizing the polymerizable material. The choice of curative for specific polymerizable materials depends on the chemical nature of the copolymerizable material. For example, in the case of epoxy resins, one would typically select a curative known for use with epoxy resins (e.g., dicyandiamide, onium salt, or polymercaptan). In the case of free-radically polymerizable resins, free radical thermal initiators and/or photoinitiators are useful curatives.

Typically, the optional curative(s) is used in an amount effective to facilitate polymerization of the monomers and the amount will vary depending upon, for example, the type of curative, the molecular weight of the curative, and the polymerization process. The optional curative(s) is typically included in the precursor composition in an amount in a range of from about 0.01 percent by weight to about 10 percent by weight, based on the total weight of the precursor composition, although higher and lower amounts may also be used. The hardcoat precursor composition may be cured, for example, by exposure to a thermal source (e.g., heat, infrared radiation), electromagnetic radiation (e.g., ultraviolet and/or visible radiation), and/or particulate radiation (e.g., electron beam of gamma radiation).

Useful free-radical photoinitiators include, for example, benzoin ethers such as benzoin methyl ether and benzoin isopropyl ether, substituted benzoin ethers (e.g., anisoin methyl ether), substituted acetophenones (e.g., 2,2-dimethoxy-2-phenylacetophenone), substituted alpha-ketols (e.g., 2-methyl-2-hydroxypropiophenone), benzophenone derivatives (e.g., benzophenone), and acylphosphine oxides. Exemplary commercially available photoinitiators include photoinitiators under the trade designation “IRGACURE” (e.g., IRGACURE™ 651, IRGACURE™ 184, and IRGACURE™ 819) or “DAROCUR” (e.g., DAROCUR™ 1173, DAROCUR™ 4265) from Ciba Specialty Chemicals, Tarrytown, N.Y., and under the trade designation “LUCIRIN” (e.g., “LUCIRIN TPO”) from BASF, Parsippany, N.J.

In typical embodiments, the hardcoat layer comprises nanoparticles. Nanoparticles may comprise a range of particle sizes over a known particle size distribution for a given material. In some embodiments, the average particle size may be within a range from about 1 nm to about 100 nm. Particle sizes and particle size distributions may be determined in a known manner including, for example, by transmission electron microscopy (TEM). Suitable nanoparticles can comprise any of a variety of materials such as metal oxides selected from alumina, tin oxide, antimony oxide, silica, zirconia, titania and combinations of two or more of the foregoing. Surface-modified colloidal nanoparticles can be substantially fully condensed.

In some embodiments, silica nanoparticles can have a particle size ranging from about 5 to about 75 nm. In some embodiments, silica nanoparticles can have a particle size ranging from about 10 to about 30 nm. Silica nanoparticles can be present in the cured hardcoat composition in an amount from about 10 to about 95 percent by weight. In some embodiments, silica nanoparticles are present in an amount of at least 25, 30, 35, 40, 45, or 50 percent by weight, and

Typically no greater than 70 percent by weight the cured hardcoat.

Silica nanoparticles suitable for use are commercially available from Nalco Chemical Co. (Naperville, Ill.) under the product designation NALCO.TM. Colloidal Silicas. Suitable silica products include NALCO™. Products 1040, 1042, 1050, 1060, 2327 and 2329. Suitable fumed silica products include for example, products sold under the tradename AEROSIL™ series OX-50, -130, -150, and -200 from DeGussa AG, (Hanau, Germany), and CAB-O-SPERSE.TM. 2095, CAB-O-SPERSE.TM. A105, CAB-O-SIL.TM. MS from Cabot Corp. (Tuscola, Ill.).

Nanoparticles can be surface modified which refers to the fact that the nanoparticles have a modified surface so that the nanoparticles provide a stable dispersion. “Stable dispersion” refers to a dispersion in which the colloidal nanoparticles do not agglomerate after standing for a period of time, such as about 24 hours, under ambient conditions, e.g., room temperature (about 20 to about 22.degree. C.), and atmospheric pressure, without extreme electromagnetic forces. The surface-treatment stabilizes the nanoparticles so that the particles will be well dispersed in the coatable composition and results in a substantially homogeneous composition. Furthermore, the nanoparticles can be modified over at least a portion of its surface with a surface treatment agent so that the stabilized particle can copolymerize or react with the coatable composition during curing.

Metal oxide nanoparticles can be treated with a surface treatment agent to make them suitable for use in the present invention. In general, a surface treatment agent has a first end that will attach to the particle surface (covalently, ionically or through strong physiosorption) and a second end that imparts compatibility of the particle with the coatable composition and/or reacts with coatable composition during curing. Examples of surface treatment agents include alcohols, amines, carboxylic acids, sulfonic acids, phosphonic acids, silanes and titanates. The type of treatment agent can depend on the nature of the metal oxide surface. For example, silanes are typically preferred for silica and other siliceous fillers. Surface modification can be accomplished either subsequent to mixing with the coatable composition or after mixing. It may be preferred in the case of silanes to react the silanes with the particle or nanoparticle surface before incorporation into the coatable composition. The amount of surface modifier can depend on factors such as particle size, particle type, modifier molecular weight, and modifier type. In general, a monolayer of modifier is attached to the surface of the particle. The attachment procedure or reaction conditions required also depend on the surface modifier used. For silanes, surface treatment may take place at elevated temperatures under acidic or basic conditions during a period of about 1 hour up to about 24 hours.

Surface treatment agents are known in the art including for example, isooctyl trimethoxy-silane, N-(3-triethoxysilylpropyl) methoxyethoxyethoxyethyl carbamate (PEG3TES), SILQUEST.TM. A1230, N-(3-triethoxysilylpropyl) methoxyethoxyethoxyethyl carbamate (PEG2TES), 3-(methacryloyloxy)propyltrimethoxysilane, 3-acryloxypropyltrimethoxysilane, 3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures of two or more of the foregoing.

Surface modification of the particles in a colloidal dispersion can be accomplished in a number of ways. The process involves the mixture of an inorganic dispersion with surface modifying agents and, optionally, a co-solvent such as, for example, 1-methoxy-2-propanol, ethanol, isopropanol, ethylene glycol, N,N-dimethylacetamide and 1-methyl-2-pyrrolidinone. Co-solvent can be added to enhance the solubility of the surface modifying agents as well as the surface modified particles. The mixture comprising the inorganic sol and surface modifying agents is subsequently reacted at room or an elevated temperature, with or without mixing. In one method, the mixture can be reacted at about 85.degree. C. for about 24 hours, resulting in the surface-modified sol. In one method, where metal oxides are surface-modified, the surface treatment of the metal oxide can involve the adsorption of acidic molecules to the particle surface. The surface modification of the heavy metal oxide preferably takes place at room temperature.

In some embodiments, at least a portion of the nanoparticles may be surface modified in the manner described above. In other embodiments, all of the nanoparticles are surface modified. In still other embodiments, none of the nanoparticles are surface modified.

The polymerizable hardcoat compositions can be formed by dissolving the free-radically polymerizable material(s) in a compatible organic solvent and then combined with the nanoparticle dispersion at a concentration of about 60 to 70 percent solids. A single or blend of the previously described organic solvent solvents can be employed.

The hardcoat composition can be applied as a single or multiple layers to a (e.g. display surface or film) substrate using conventional film application techniques. Thin films can be applied using a variety of techniques, including dip coating, forward and reverse roll coating, wire wound rod coating, and die coating. Die coaters include knife coaters, slot coaters, slide coaters, fluid bearing coaters, slide curtain coaters, drop die curtain coaters, and extrusion coaters among others. Many types of die coaters are described in the literature. Although it is usually convenient for the substrate to be in the form of a roll of continuous web, the coatings may be applied to individual sheets.

The hardcoat composition is dried in an oven to remove the solvent and then cured for example by exposure to ultraviolet radiation using an H-bulb or other lamp at a desired wavelength, preferably in an inert atmosphere (less than 50 parts per million oxygen). The reaction mechanism causes the free-radically polymerizable materials to crosslink.

The thickness of the cured hardcoat surface layer is typically at least 0.5 microns, 1 micron, or 2 microns. The thickness of the hardcoat layer is generally no greater than 50 microns or 25 microns. Preferably the thickness ranges from about 5 microns to 15 microns.

In one embodiment, the method for making an embodied article comprises: (a) providing an organic polymeric (e.g. film) base member having a (e.g. front) surface wherein at least a portion of the surface comprises a siliceous (e.g. DLG) thin film layer; (b) applying the previously described C8-C36 silane compound(s) to at least a portion of the siliceous layer; and (c) (e.g. thermally) curing such that the silyl group of the silane compounds forms a siloxane bond with the siliceous (e.g. DLG) thin film layer.

In another embodiment, the method for making an embodied article comprises: (a) providing an organic polymeric (e.g. film) base member layer having a (e.g. front) surface (b) providing a hardcoat layer on the front surface by (b1) applying a hardcoat composition and (b2) curing the hardcoat composition; (c) depositing a siliceous (e.g. DLG) thin film layer onto the hardcoat composition; (d) providing a surface layer by (d1) applying the previously described C8-C36 silane compound(s) to at least a portion of the siliceous layer; and (d2) (e.g. thermally) curing such that the silyl group of the silane compounds forms a siloxane bond with the siliceous (e.g. DLG) thin film layer.

Unlike the surface layer of US2014/0329012, that is characterized as being “hydrophilic” the surface layer described herein is hydrophobic. The terms “hydrophobic” refers to a surface on which drops of water or aqueous solutions exhibit a static water contact angle of at least 50 degrees, at least 60 degrees, at least 70 degrees, at least 80 degrees, or at least 85 degrees. In some embodiments, the static water contact angle is less than 100, 95 or 90 degrees.

In some embodiments, the surface layer is easy to clean, as evidenced by the dry erase and permanent marker removability. Illustrative applications where easy cleanability is desired include windows, electronic device screens, work surfaces, appliances, door and wall surfaces, signs, etc. In this embodiment, the surface layer may not be writable.

In some embodiments, the article is a dry erase article or component thereof. The dry erase article can further comprise other optional components such as frames, means for storing materials and tools such as writing instruments, erasers, cloths, note paper, etc., handles for carrying, protective covers, means for hanging on vertical surfaces, easels, etc.

Other articles that include writable surfaces file folders, notebooks, binders etc. where effective writability coupled with later easy removal of the writing is desired.

The writable surface layers generally exhibit no dewetting with both dry erase markers and permanent markers.

As described in WO 2011/094342, solvent compositions of dry erase markers are typically listed on the marker or reported on the MSDS for the marker. Common solvents for dry erase markers include, for example, ethanol, isopropanol, methyl isobutyl ketone and n-butyl acetate. One solvent with a high surface tension is n-butyl acetate, having a surface tension of about 25 mJ/m². Therefore, in some embodiments, a dry ease surface can be wettable by solvents with a surface tension of about 25 mJ/m² or less. In one embodiment, the surface energy of the writing surface is within the range of about 26 mJ/m² to less than about 38 mJ/m². In another embodiment, the surface energy of the writing surface is within the range of about 30 mJ/m² to less than about 38 mJ/m².

Permanent markers can have many of the same solvents as dry erase markers. However, permanent markers are generally “waterproof” after evaporation of the solvent due to the other components of the permanent markers and are not dry erasable. For example, if a 1 inch filled square is drawn on a piece of glass and allowed to dry for 24 hours, the ink from a dry erase marker can typically be removed using the test for dry erase marker writing erasability described in the forthcoming examples. However, a 1 inch filled square drawn on a piece of glass with a permanent marker (e.g. black Sharpie™ and allowed to dry for 24 hours cannot be removed using this same test.

In contrast to US2014/0329012 that describes removing permanent marker writing from the surface by simply applying water (e.g., tap water at room temperature) and/or water vapor (e.g., a person's breath) and wiping, permanent marker writing can be removed from with a dry paper towel according to the test method described in the examples.

A variety of other dry eraser types can be used. Illustrative examples of eraser materials include pressed and woven felts of synthetic and/or natural (e.g., wool) materials, cellulose, foam rubber, neoprene, cloth, pile fabrics, melamine fibers, and similar materials have been used. Preferably the eraser materials chosen is not abrasive in nature so as to enhance the durability of the writing surface.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or known to those skilled in the art unless otherwise stated or apparent.

These abbreviations are used in the following examples: g=gram, hr=hour, kg=kilograms, min=minutes, mol=mole; cm=centimeter, mm=millimeter, mL=milliliter, L=liter, MPa=megaPascals, and wt=weight.

### Materials

| Material | |
|---|---|
| Name/Designation | Description |
| White PET | 7 mil (105 micrometer) thick, white polyester film chemically primed |
| | on both sides, obtained from Mitsubishi PET film LLC, Greenville, SC |
| | under trade designation “W54B” |
| SR444 | Multifunctional acrylate (pentaerythritol triacrylate), obtained from |
| | Sartomer Americas, West Chester, PA under trade designation |
| | “SARTOMER SR444” |
| SR368D | Multifunctional acrylate (tris (2-hydroxy ethyl) isocyanurate tri |
| | acrylate), obtained from Sartomer Americas, West Chester, PA under |
| | trade designation “SARTOMER SR368D” |
| A174 | 3-(Trimethoxysilyl)propyl methacrylate, obtained from Momentive |
| | Performance Materials Inc., Waterford, NY under trade designation |
| | “SILQUEST A-174” |
| Nano-silica | Silica sol, 40 wt. % solids, 20 nm particle size, obtained from Nalco |
| | Corporation, Naperville, IL under trade designation “NALCO 2327” |
| C18 silane | 1-Octyldecyl trimethoxysilane, MW = 374.7, obtained from Gelest, |
| | Inc., Morrisville, PA |
| C16 silane | 1-Hexadecyl trimethoxysilane, MW = 346.6, obtained from Gelest, Inc., |
| | Morrisville, PA |
| C12 silane | 1-Dodecyl trimethoxy silane, MW = 290.5, obtained from Gelest, Inc., |
| | Morrisville, PA |
| C10 silane | 1-Decyl trimethoxy silane, MW = 262.5, obtained from Gelest, Inc., |
| | Morrisville, PA |
| C8 silane | 1-Octyl trimethoxy silane, MW = 234.4, obtained from Gelest, Inc., |
| | Morrisville, PA |
| I GLASSCLAD | Partially hydrolyzed 1-Octyldecyl trimethoxysilane, obtained from |
| | Gelest, Inc., Morrisville, PA, under trade designation “GLASSCLAD |
| | 18” |
| PEO silane | Trimethyoxy silane terminated polyethylene oxide, MW = 2,000, |
| | obtained from Gelest, Inc., Morrisville, PA |
| AQUAPHOBE CM | Chlorine terminated polydimethysiloxanes, obtained from Gelest, Inc., |
| | Morrisville, PA, under trade designation “AQUAPHOBE CM) |
| Acetic acid | Acetic acid, reagent grade, obtained from Sigma Aldrich Chemical |
| | Co., St. Louis, MO |
| ESACURE ONE | Difunctional alpha-hydroxy ketone photoinitiator for UV curing, |
| | obtained from Lamberti USA Inc., Conshohocken, PA, under trade |
| | designation “ESACURE ONE” |
| IPA | Isopropanol, reagent agent, obtained from Avantor Performance |
| | Materials, LLC, Center Valley, PA |
| Ethyl acetate | Ethyl acetate, reagent grade, obtained from Brenntag Grate Lakes, |
| | Bethlehem, PA |
| 1-Methoxy-2-propanol | Obtained from Dow Chemical Company, Midland MI under trade |
| | designation “DOWANOL PM” |
| MAGIC TAPE | Adhesive tape, obtained from 3M Company, St. Paul, MN, under trade |
| | designation “3M SCOTCH #810 MAGIC TAPE” |
| Avery Mark-A-Lot | Dry erase marker, chisel point, obtained from Avery-Dennison |
| | Corporation, Glendale, CA under trade designation “AVERY |
| | MARKS-A-LOT DRY ERASE MARKERS” |
| BIC Great Erase Bold | Dry erase marker, obtained from Société BIC S.A, Clichy Cedex, |
| | FRANCE under trade designation “BIC GREAT ERASE DRY- |
| | ERASE MARKERS” |
| SRX Dry Erase Marker | Dry erase marker, obtained from MEGA Brands Inc., Montreal, QC, |
| | CANADA under treade designation “SRX DRY ERASE MARKER” |
| Expo Bold Color Dry | Dry erase marker, obtained from Sanford Corporation, Bellwood, |
| Erase | Illinois under trade designation” EXPO BOLD DRY-ERASE |
| | MARKERS” |
| Quartet EnduraGlide | Dry erase marker, obtained from Acco, Inc., Lake Zurich, IL under |
| | trade designation “QUARTET ENDURAGLIDE DRY-ERASE |
| | MARKERS” |
| Staples Remarx | Dry erase marker, obtained from Staples, Inc., Arden Hills, MN under |
| | tared designation “STAPLES REMARX DRY-ERASE MARKERS” |
| Sharpie Marker | Permanent marker, fine point, obtained from Sanford Corporation, |
| | Bellwood, IL under trade designation “SHARPIE FINE POINT |
| | PERMANENT MARKERS” |
| Avery Mark-A-Lot | Permanent marker, chisel point, obtained from Avery-Dennison |
| | Corporation, Glendale, CA under trade designation “AVERY |
| | MARKS-A-LOT PERMANENT MARKERS” |
| BIC Markers | Permanent marker, fine point obtained from Société BIC S.A, Clichy |
| | Cedex, FRANCE under trade designation “BIC MARK-IT |
| | PERMANENT MARKERS” |

### Test Methods

### Test for Dry Erase/Permanent Marker Dewetting

14 different markers (selected from a total of 7 brands of dry erase and permanent markers listed above) were used for this test. Two colors of markers from each brand were chosen, one black and the other selected from red, green, or blue. Samples prepared according to the Examples and Comparative Examples prepared as described below were tested. The test samples were about 6 inches by 11 inches (15.0 cm by 27.9 cm) in size. A horizontal band (i.e., along the width of the samples) about 2.5 cm wide of the sample was reserved for each marker brand. The first marker was used to write the marker brand name on the left hand side of the 2.5 cm wide band and the second marker was used to write the same marker brand name on the right hand side of the 2.5 cm wide band. In this manner, all the markings (i.e. brand names) written for each marker brand was lined up in one erasable horizontal line. After marking with each of the markers for all brands on the test sample, each ink line (for each brand) was examined visually for dewetting. Dewetting (i.e., beading-up) of the dry erase ink was evidenced by visual appearance of gaps in the ink line or a shrinking of the ink line.

### Test for Dry Erase Marker Writing Erasability

The surfaces of samples prepared according to the Examples and Comparative Examples described below were marked with 14 dry erase markers and then were placed in an oven to allow the markings to dry at 50° C. for one week. The film samples were then taken out from the oven and cooled down to room temperature, followed by placing on a hard, flat surface. An EXPO eraser (obtained from obtained from Sanford Corporation, Bellwood, Illinois under trade designation “EXPO DRY-ERASE ERASERS”) was used to erase the writing. The area of the eraser in contact with the writing surface was about 12.5 cm×5 cm. A 12.5 cm×5 cm brass weight weighing 2.5 kg was placed on top of the eraser, resulting in a pressure of 0.4N/cm². The weighted eraser was passed over the first line of markings without additional hand pressure, in a back and forth motion until ten back and forth motions (total of 10 passes over the markings) had been completed. The samples were then visually evaluated and rated for erasability according to the following scale. 1: >75% ink remaining on the surface; 2: 50-75% ink remaining on the surface; 3: 25-50% ink remaining on the surface; 4: <25% ink remaining on the surface.

### Test for Permanent Marker Writing Erasability

The surfaces of samples prepared according to the Examples and Comparative Examples described below marked with permanent markers were evaluated for erasability by rubbing the marked surface of the samples with a paper towel. The marked films were rubbed by hand, using moderate pressure (2.9 lbs per 1 in² of erasing medium contacting the surface), in a back and forth motion (3 passes per second) until either the marking was completely erased or until ten back and forth motions had been completed (a total of 10 passes over the markings). The film samples were then visually evaluated and rated for erasability according to the following scale. 1=rubbing with paper towel had no effect on the marking; 2=marking was partially removed and was still readable; 3=most of the marking was removed with noticeable ink smearing; 4=the marking was completely and cleanly removed.

### Test of Release Force Measurement

Peel adhesion force for removing of 3M MAGIC TAPE from the surfaces of samples prepared according to Examples and Comparative Examples described below was measured on a slip/peel tester (IMASS-2000 slip/peel tester, obtained from IMASS, Inc., Accord MA). A 10 inch (25 cm) long strip of 3M MAGIC TAPE was placed on to sample surface and was pressed by a 2.04 kg rubber roller. The tape was peeled at 180 degree angle at 90 in/min (2.29 m/min) rate. The average peeling force was recorded on 3 replicates.

### Bend Test

The bend test was carried out according to ASTM D3111-10“Standard Test Method for Flexibility Determination of Hot-Melt Adhesives by Mandrel bend Test Method”. The test specimens prepared according to the Examples described below were cut into sheets of about 20 by 25 mm. Each sheet was then wrapped 180 degrees around a metal rod with a diameter of 6.4 mm (¼in) within 1 second with the coated side of the specimen being on the outside of the mandrel. The specimen was then removed from the mandrel and was visually examined. A “PASS” rating meant the absence of visible fracture, crazing, or cracking of the coating or the substrate or de-bonding of the coating from the substrate. Alternatively, a “FAIL” rating meant appearance of visible fracture, crazing, or cracking of the coating or the substrate or de-bonding of the coating from the substrate.

### Test for Static Water Contact Angle

Water contact angle measurements were performed on dried samples prepared according to Examples and Comparative Examples described below. Deionized water, obtained from Millipore Corporation (Billerica, Mass.). The contact angle analyzer used was a PGX+ video contact angle analyzer from FIBRO System AB, Hagersten, Sweden. The contact angle was measured using a built-in camera on drops of water (0.5 μL) delivered by an integrated pump. The values reported are the average of at least 4 separate measurements.

### Preparation of Surface Modified Silica Nanoparticles

A 12 liter flask was charged with 3000 g of aqueous colloidal silica solution NALCO2327 and stirring was started. Then 3591 g of 1-methoxy-2-propanol was added. In a separate container, 189.1 g of 3-methacryloxypropyltrimethoxy silane (A-174) was mixed with 455 g of 1-methoxy-2-propanol. This pre-mix solution was added to the flask, rinsing with 455 g of 1-methoxy-2-propanol. The mixture was heated to 80° C. for about 16 hours. The mixture was cooled to 35° C. The mixture was set up for vacuum distillation (30 to 35 Torr (4-6.67 kPa), 35 to 40° C.) with a collection flask. An additional 1813.5 g of 1-methoxy-2-propanol was added to the reaction flask part way through the distillation. A total of 6784 g of distillate was collected. The mixture was tested for % solids by drying a small sample in a tared aluminum pan for 60 minutes in a 105° C. oven. The mixture was found to be 52.8% solids. An additional 250 g of 1-methoxy-2-propanol was added and the mixture was stirred. The % solids was tested and found to be 48.2%. The mixture was collected by filtering through cheesecloth to remove particulate debris.

### General Coating Procedure

A PET film web about 6 inches (15 cm) wide was used as substrate. A hardcoat solution containing SR 444, A 174, surface modified silica nanoparticles, and ESACURE ONE (at a wt. ratio of 43:5:50:2) was coated on to the PET substrate using gravure coating method. The hardcoated sample was dried at 60° C. for 30 seconds and then-exposed to UV light (300 W H-bulb obtained from Hareus Noblelight America, LLC, Gaithersburg, Md.) at a rate of 20 ft/min (6.1 m/min). The UV lamp was located about 1 inch (2.5 cm) above the sample and the surface of the dried hardcoat was purged with nitrogen while curing. Energy input used for UV curing was 60 milliJoules of UVC radiation. The dry thickness of the hardcoat on the film was 4-5 micrometers. The hardcoat applied in this manner is referred to hereinafter as the “standard hardcoat”.

A DLG layer was deposited onto the cured hardcoat surface of the hardcoated PET film prepared as described above using a 2-step web process. A homebuilt plasma treatment system described in detail in U.S. Pat. No. 5,888,594 (David et al.) was used with some modifications: the width of the drum electrode was increased to 42.5 inches (108 cm) and the separation between the two compartments within the plasma system was removed so that all the pumping was carried out by means of the turbo-molecular pump and thus operating at a process pressure of around 10-50 mTorr (1.33-6.7 Pa).

A roll of hardcoated polymeric film from above was mounted within the chamber, the film wrapping around the drum electrode and secured to the take up roll on the opposite side of the drum. The unwind and take-up tensions were maintained at 8 pounds (13.3 N) and 14 pounds (23.3 N) respectively. The chamber door was closed and the chamber was pumped down to a base pressure of 5×10⁻⁴ torr (6.7 Pa). For the deposition step, hexamethyldisiloxane (HMDSO) and oxygen were introduced at a flow rate of 200 standard cm³/min and 1000 standard cm³/min respectively, and the operating pressure was nominally at 35 mTorr (4.67 Pa). Plasma was turned on at a power of 9500 watts by applying rf power to the drum and the drum rotation initiated so that the film was transported at a speed of 10 feet/min (3 m/min). The run was continued until the entire length of the film on the roll was completed.

After the completion of the DLG deposition step, the rf power was disabled, the flow of HMDSO vapor was stopped, and the oxygen flow rate increased to 2000 standard cm³/min. Upon stabilization of the flow rate, and pressure, plasma was reinitiated at 4000 watts, and the web transported in the opposite direction at a speed of 10 ft/min (3 m/min), with the pressure stabilizing nominally at 14 mTorr (1.87 Pa). This second plasma treatment step was to remove the methyl groups from the DLG film, and to replace them with oxygen containing functionalities, such as Si—OH groups, which facilitated the grafting of the silane compounds to the DLG film.

After the entire roll of film was treated in the above manner, the rf power was disabled, oxygen flow stopped, chamber vented to the atmosphere, and the roll taken out of the plasma system for further processing.

The thickness of resulting DLG layer was about 100 nm.

Finally a silane coating was applied over the DLG layer from a silane solution using a #5 Mayer bar. The silane solution contained a mixture of desired silanes (as described for Examples and Comparative Examples below) in IPA. The concentration of the silanes was 2 wt. % silanes in IPA with respect to the total weight of the solution. Additionally, the silane mixture contained 2 wt. % of acetic acid (with respect to the weight of silanes) as catalyst. The silane coating was then thermally cured at 280° F. (137.8° C.) for 5 minutes.

### Examples 1-16 and Comparative Examples A-F

Examples 1B and 2-16 were prepared by using the “General Coating Procedure” described above. The amount and the weight ratios of C8-C18 silanes in the silane coating solution was varied as summarized in Table 1, below.

Example 1A was prepared by using the “General Coating Procedure” described above, except that no hardcoat was applied on the PET film substrate before depositing the DLG layer.

Comparative Example A sample was bare PET film used as received without any further treatments.

Comparative Example B was the surface of a commercially available dry erase board used as received without any further treatments. Such surface contained a cured hardcoat including a fluorinated acrylate additive.

Comparative Example C was prepared by using the “General Coating Procedure” described above, except that no silane coating was applied after depositing the DLG layer.

Comparative Examples D and E were prepared by using the “General Coating Procedure” described above. The silane in the silane coating solution was PEO silane for Comparative Example D and AQUAPHOBE CM for Comparative Example E.

The Examples and Comparative Examples samples were tested using the test methods described above. The results are summarized in Table 1, below.

TABLE 1

| | | Dry Erase | | | |
|---|---|---|---|---|---|
| | | Marker | | | |
| | Silanes | Dewetting/ | Permanent | Permanent | Peel |
| | (wt. ratio of | Marker | Marker | Marker | Adhesion |
| Example | silanes) | Removability | Dewetting | Removability | Force (g) |
| Comp. A | None | — | None | 1 | — |
| No | | | | | |
| Hardcoat | | | | | |
| Comp. B | None | None/3 | None | 2 | 451.33 |
| Comp. C | None | — | None | 2 | — |
| Comp. D | PEO Silane | — | — | — | 132.68 |
| Comp. E | PMDS Silane | Yes/4 | — | — | 11.62 |
| 1A | C18 Silane | | N/A | 2 | |
| | Without | | | | |
| | hardcoat | | | | |
| 1B | C18 Silane | Yes/4 | Yes | 4 | 28.35 |
| 2 | C8 Silane | None/4 | None | 3 | — |
| 3 | C12 Silane | — | None | 3 | — |
| 4 | C16 Silane | — | None | 3 | — |
| 5 | C8/C18 Silane | — | None | 3 | — |
| | (19:1) | | | | |
| 6 | C8/C18 Silane | — | None | 4 | — |
| | (9:1) | | | | |
| 7 | C8/C18 Silane | — | None | 4 | — |
| | (4:1) | | | | |
| 8 | C8/C18 Silane | — | None | 4 | — |
| | (3:1) | | | | |
| 9 | C8/C18 Silane | — | None | 4 | — |
| | (2:1) | | | | |
| 10 | C8/C18 Silane | — | Yes | 4 | — |
| | (1:1) | | | | |
| 11 | C12/C18 | — | None | 4 | — |
| | Silane (9:1) | | | | |
| 12 | C12/C18 | — | None | 4 | — |
| | Silane (4:1) | | | | |
| 13 | C16/C18 | — | None | 4 | — |
| | Silane (19:1) | | | | |
| 14 | C16/C18 | None/4 | None | 4 | — |
| | Silane (9:1) | | | | |
| 15 | C16/C18 | — | Yes | 4 | — |
| | Silane (4:1) | | | | |
| 16 | GLASSGUARD | — | — | — | 24.95 |

“—” means the sample was not tested.

Examples 1A and 1B samples were tested according to the bend test described above and both samples received a “PASS” rating.

Examples 1A and 1B samples were tested for static water contact angles using the test described above. The static water contact angles for Examples 1A and 1B were 88.70 and 85.40, respectively.

What is claimed is:

1. An article comprising:
a surface layer comprising at least one C8-C36 hydrocarbon silane compound siloxane bonded to a siliceous layer, the siliceous layer having a porosity of no greater than 10% and a thickness no greater than 1 micron.

2. The article of claim 1 wherein the siliceous layer comprises 10 to 50 atomic percent carbon.

3. The article of claims 1-2 wherein the siliceous layer is a diamond-like glass layer.

4. The article of claims 1-3 wherein the siliceous layer has a refractive index greater than 1.458.

5. The article of claims 1-4 further comprising an organic polymeric base member.

6. The article of claim 5 wherein the organic polymeric base member is a film.

7. The article of claims 5-6 wherein the article further comprises a hardcoat layer disposed between the organic polymeric base member and diamond-like glass layer.

8. The article of claim 7 wherein the hardcoat comprises inorganic oxide particles.

9. The article of claims 1-8 wherein the at least one C8-C36 hydrocarbon silane has the formula
R¹—Si(R²)₃₋ₓ(R³)ₓ
wherein R¹ is a 8-36 hydrocarbon group;
R² is a hydrolysable group;
R³ is a non-hydrolysable group that is not R¹; and
x ranges from 0 to 2.

10. The article of claim 9 wherein R² is hydroxyl or a C1-C4 alkoxy group.

11. The article of claims 9-10 wherein R¹ is a C8-C17 alkyl group.

12. The article of claims 9-10 wherein R¹ is a C18-C36 alkyl group.

13. The article of claims 9-10 wherein the surface layer comprises the reaction product of
i) at least one first hydrocarbon silane compound wherein R¹ is a C8-C17 alkyl group; and
ii) at least one second hydrocarbon silane compound wherein R¹ is a C18-C36 alkyl group.

14. The article of claim 13 wherein the first silane compounds are present in an amount greater than the second silane compounds.

15. The article of claims 1-14 wherein the surface layer comprises at least 90 or 95 wt.-% of reaction products of C8-C36 hydrocarbon silane compounds.

16. The article of claims 1-15 wherein the surface layer is a release layer.

17. The article of claims 1-15 wherein the article is a dry erase board.

18. The article of claim 17 wherein permanent marker can be removed from the surface layer with a dry paper towel.

19. An article comprising:
a surface layer comprising at least one C8-C22 hydrocarbon silane compound siloxane bonded to a siliceous layer, the siliceous layer comprising 30 to 50 atomic percent carbon and a thickness no greater than 1 micron.

20. The article of claim 19 further characterized by any one or combination of claims 3-18.

21. A coating composition comprising
i) at least one hydrocarbon silane compound having the formula
R¹—Si(R²)₃₋ₓ(R³)ₓ
wherein R¹ is a C8-C17 hydrocarbon silane;
R² is a hydrolysable group;
R³ is a non-hydrolysable group that is not R¹; and
x ranges from 0 to 2; and
ii) at least one hydrocarbon silane compound having the formula
R¹—Si(R²)₃₋ₓ(R³)ₓ
wherein R¹ is a C18-C36 hydrocarbon silane;
R² is a hydrolysable group;
R³ is a non-hydrolysable group; and
x ranges from 0 to 2; and
iii) optionally an organic solvent.

22. The composition of claim 21 wherein i) and ii) are present at a weight ratio of greater than 1:1.

23. The reaction product of the composition of claims 21-22 with a siliceous surface.
